(19) United States
(12) Patent Application Publication
(10) Pub. No.: US 2025/0077863 A1
(43) Pub. Date: Mar. 6, 2025

(54) SYSTEM AND METHOD FOR JOINTLY OPTIMAL INCREMENTAL LEARNING WITH LARGE LANGUAGE MODELS

(71) Applicant: Leidos, Inc., Reston, VA (US)

(72) Inventor: Hanna Witzgall, Chantilly, VA (US)

(73) Assignee: Leidos, Inc., Reston, VA (US)

(21) Appl. No.: 18/815,978

(22) Filed: Aug. 27, 2024

Related U.S. Application Data
(60) Provisional application No. 63/579,151, filed on Aug. 28, 2023.
(60) Provisional application No. 63/579,144, filed on Aug. 28, 2023.
(60) Provisional application No. 63/659,026, filed on Jun. 12, 2024.

(51) Int. Cl. G06N 3/08; G06F 40/284

(52) U.S. Cl. CPC G06N 3/08; G06F 40/284

(57) ABSTRACT

Ridge Regression for Rapid Class Augmentation (R3CA), a regularized version of the XRCA incremental learning algorithm, is applied to large language model classification tasks such as topic classification, e.g., given a text article, determining to which predetermined topic category it should be classified, and name-entity-recognition (NER), e.g., identifying new named-entities such as a word or word phrase representing a person, organization, geographical location, art-artifact, event or nationality.

### CROSS-REFERENCE TO RELATED APPLICATIONS

The present application claims the benefit of priority to U.S. Provisional Patent Application No. 63/659,026 entitled JOINTLY OPTIMAL INCREMENTAL LEARNING WITH LARGE LANGUAGE MODELS, filed Jun. 12, 2024; U.S. Provisional Patent Application No. 63/579,151 entitled RIDGE REGRESSION FOR RAPID CLASS AUGMENTATION filed Aug. 28, 2023; and U.S. Provisional Patent Application No. 63/579,144 entitled JOINTLY OPTIMAL INCREMENTAL LEARNING WITH SELF-SUPERVISED VISION TRANSFORMERS filed Aug. 28, 2023, each of which is incorporated herein by reference in its entirety.

Cross-reference is made to commonly-owned U.S. application Ser. No. 17/083,969 entitled DEEP RAPID CLASS AUGMENTATION filed Oct. 29, 2020 and U.S. application Ser. No. 17/840,238 entitled METHOD AND SYSTEM FOR ACCELERATING RAPID CLASS AUGMENTATION FOR OBJECT DETECTION IN DEEP NEURAL NETWORKS filed Jun. 14, 2022, which are incorporated herein by reference in their entirety.

### BACKGROUND

### Field of Embodiments

Generally, the field is continuous learning (CL) algorithms. More specifically, the field of the embodiments herein focus on improved incremental learning applications and how it can be applied in the field of natural language processing (NPL).

### Description of Related Art

Deep neural networks (DNNs) continue to enable revolutionary advances in machine learning's classification performance. However, these networks typically utilize training procedures that have difficulty continuously learning from un-curated and unshuffled streams of data.

One fundamental challenge for CL algorithms is that current optimizers struggle to retain previously learned knowledge when adapting to new information. The issue is that standard optimizers, like stochastic gradient descent (SGD), base the network's training updates on just what is in the current training batch. When trained incrementally on just the new class data, this causes the optimizer to overfit the network's weights to the new class data without regard as to how these weight changes affect the performance on previously learned classes. The resulting performance degradation on the previously learned classes is known as catastrophic forgetting (CF) and the resolution of this issues has proven elusive.

The lack of a reliable incremental learning algorithm means that many applications simply forgo CL approaches altogether and resort to the inefficiency of standard training procedures that necessitate retraining the model over the entire, enlarged dataset. But this solution is time-consuming and costly in terms of compute power and training data storage and motivates research efforts into developing better incremental training solutions.

Many incremental learning approaches can be broadly classified into replay/rehearsal methods, parameter isolation/ensemble methods, and regularization techniques depending on how the memory of earlier classes is parlayed into their incremental updates.

Replay or rehearsal methods make a direct approach to preserving the memory of prior classes by saving important samples of prior classes and replaying them during the training of the new class, so the old class data is not forgotten. A notable replay method is called iCARL, which stores a subset of exemplars per class, which are selected to best approximate the class means in the learned feature space. At test time the class means are calculated for nearest mean classification based on all exemplars.

However, these types of replay and rehearsal methods have not been shown to eliminate CF especially for training scenarios involving long training sequences that have a memory constraint on the number of exemplars maintained. Furthermore, because these replay methods often use a nearest neighbor classification method they require significantly longer inference times than regular classifiers because they run thru all their training exemplars.

Ensemble and parameter isolation methods incorporate memory of prior tasks by dedicating different models or a subset of model parameters to each specific task to avoid any interclass interference. When no size constraints are applied, one can grow new branches for each new task while freezing previous task parameters. Alternative methods use a static network architecture with fixed parameters allocated to each task. Life-long Machine Learning and PathNet are examples of ensemble and parameter isolation respectively.

A drawback of these methods is that they typically require a task oracle to identify which corresponding sub-models or branches to use for a particular classification task. This task oracle amounts to a type of inference time label which is often not available and limits their utility.

Regularization approaches try to incorporate memory of earlier classes into their weight updates by modifying the loss function to penalize changes to a network's weights that were deemed important to earlier classes. A well-known regularization approach to incremental learning is the Elastic Weight Consolidation (EWC) method that attempts to mitigate forgetting by penalizing changes to parameters that were deemed important for previous tasks. The importance of model parameters was determined using the Fisher Information Matrix.

A benefit of regularization methods is that they avoid the storing of raw inputs, prioritize privacy, and alleviate memory requirements. In addition, they typically have fast inference times. However, they only have a tenuous theoretical justification for mitigating CF which is often not supported empirically.

However, none of these incremental learning strategies has been able to reliably eliminate CF. Furthermore, all these techniques are demonstrated using offline, episodic training on data that has clear task boundaries. And all these techniques rely on the restrictive assumption that each new class increment has sufficient training data to completely learn a new class. In addition, many of these techniques cannot easily handle revisiting a previously learned task with additional training data. Finally, none of these techniques consider a multi-head classifier and the issues of CF for joint optimization over a multi-class data stream. Therefore, there appears to be significant gaps remaining to complete the vision of being able to continuously learn on unfiltered streams of data or even on the narrower objectives of learning new tasks in serial.

Furthermore, many incremental learning methods impose additional learning restrictions to simplify the problem. For example, a working assumption in this field is that a model will have access to all a new task's data whenever it is incrementally added. This allows the methods to assume that a new task can be completely learned before moving onto the next task. This assumption allows offline solutions with their episodic training methods, but inhibits CL's goals for online, real-time learning methods. It also ignores other desirable CL objectives such as providing training techniques with task revisit capabilities or learning without distinct task boundaries on the training batches. Constant memory is another advantageous attribute that is ignored by some incremental learning methods.

In addition to being able to learn new classes incrementally, CL algorithms would like to be able to rapidly update existing models on a stream of data in an online manner. In general, online learning refers to learning from a single pass of the data with non-episodic training with the goal of enabling a model to rapidly adapt to changing data statistics while alleviating the high data storage requirements and compute costs associated with offline training paradigms.

Online learning usually implies updating a single-class model. This standard implication avoids the issues that arise when training a multi-class model in an online manner on a data stream of unshuffled, multi-class data. The problem is again caused because of the lack of memory in standard optimizers. Since these optimizers have essentially no long-term memory of prior training batches, they require each batch have an independent and identically distributed (i.i.d.) mixture of classes. These curated, i.i.d. mixed-class batches ensure balanced class weight updates and prevent the optimizer from periodically overfitting to a particular class due to the order with which the training examples arrive in the data stream. This shuffled, mixed-class batch requirement limits the utility of standard optimizers for many online, multi-class applications and redirects most multi-class learning solutions back towards offline solutions on curated batches with multi-pass episodic training over the entire training data set.

Thus, ideally, a CL algorithm would jointly optimize a multi-class classifier in an incremental and online manner that is unaffected by the training sample arrival order. The additional challenge of mitigating CF in a jointly optimal, multi-class classifier is most often unsatisfactorily addressed by simply using a separate, single-class prediction head every time a new class is added. Once trained, the class prediction head is frozen and a new class can be added. This approach avoids the difficulty of mitigating CF in a multi-class classifier that is trained using just the new class data. But this single-class prediction approach precludes joint optimization over past and present classes. Furthermore, it leads to degradation in the previously learned classes due to the mismatch between the frozen classifier weights of prior classes and the newly updated unfrozen features upon which those classifiers operate.

### SUMMARY OF THE EMBODIMENTS

In a first non-limiting exemplary embodiment, a system for incrementally training a classifier for predicting an article's topic class includes: a tokenizer for translating words of each input text article into token vector word embeddings; a transformer backbone for (i) multiplying the token vector embeddings with a positional coding and appending a class token thereto; (ii) transforming, by an encoder, the token vector embeddings with positional coding to determine a relative context between the different token vector word embeddings for the text article; (iii) summarizing the text article's sequence of transformed token vector embeddings with positional coding in a single vector class-token embedding; and an incremental classifier trained on known topic classes for (iv) receiving the single vector class-token embedding and determining that the text article is directed to a new topic class; (v) augmenting a classification matrix with a new null-class weight vector; and (vi) training the incremental classifier on feature samples corresponding to the text article directed to the new topic class.

In a second non-limiting exemplary embodiment, a system for incrementally training a classifier for predicting classification of one or more entities in a text article includes: a tokenizer for translating words of each input text article into token vector word embeddings; a transformer backbone for (i) multiplying the token vector embeddings with a positional coding and appending a class token thereto; (ii) transforming, by an encoder, the token vector embeddings with positional coding to determine a relative context between the different token vector word embeddings for the text article; (iii) summarizing the text article's sequence of transformed token vector embeddings with positional coding in a single vector class-token embedding; and an incremental classifier trained on known entity classes for (iv) receiving each transformed token vector embedding with positional coding and determining that the text article includes a new entity class; (v) augmenting a classification matrix with a new null-class weight vector; and (vi) training the incremental classifier on feature samples corresponding to the text article directed to the new entity class.

In a third non-limiting exemplary embodiment, a non-transitory computer-readable storage medium having computer-executable instructions stored thereon for predicting an article's topic class, which when executed by one or more processors, cause the one or more processors to perform operations comprising: tokenizing words of an input text article into token vector word embeddings; multiplying the token vector embeddings with a positional coding and appending a class token thereto; transforming the token vector embeddings with positional coding to determine a relative context between the different token vector word embeddings for the input text article; summarizing the input text article's sequence of transformed token vector embeddings with positional coding in a single vector class-token embedding; receiving the single vector class-token embedding at a classifier trained on known topic classes and determining that the input text article is directed to a new topic class; augmenting a classification matrix with a new null-class weight vector; and training the incremental classifier on feature samples corresponding to the input text article directed to the new topic class.

In a fourth non-limiting embodiment, a non-transitory computer-readable storage medium having computer-executable instructions stored thereon for incrementally training a classifier for predicting classification of one or more entities in a text article, which when executed by one or more processors, cause the one or more processors to perform operations comprising:
multiplying the token vector embeddings with a positional coding and appending a class token thereto; transforming, by an encoder, the token vector embeddings with positional coding to determine a relative context between the different token vector word embeddings for the text article; summarizing the text article's sequence of transformed token vector embeddings with positional coding in a single vector class-token embedding; receiving each transformed token vector embedding with positional coding and determining that the text article includes a new entity class; augmenting a classification matrix with a new null-class weight vector; and training the incremental classifier on feature samples corresponding to the text article directed to the new entity class.

### BRIEF DESCRIPTION OF THE FIGURES

Example embodiments will become more fully understood from the detailed description given herein below and the accompanying drawings, wherein like elements are represented by like reference characters, which are given by way of illustration only and thus are not limitative of the example embodiments herein.

FIG. 1 provides a block diagram of our approach for topic classification using a R3CA incremental classifier in accordance with an embodiment herein;

FIG. 2 provides experimental results for R3CA incremental learning for topic classification in accordance with an embodiment herein;

FIG. 3 provides experimental results for R3CA incremental learning for topic classification with reduced sample support in accordance with an embodiment herein;

FIG. 4 provides a block diagram of our approach for name-entity-recognition (NER) using a R3CA in accordance with an embodiment herein;

FIG. 5 provides experimental results for R3CA incremental learning for NEM over a first 9 classes in accordance with an embodiment herein;

FIG. 6 illustrates R3CA impact of new class learning on old class accuracy in accordance with an embodiment herein; and

FIG. 7 illustrates R3CA incremental learning in NER over last 7 classes in accordance with an embodiment herein.

### DETAILED DESCRIPTION

The ability to continuously learn from a stream of data has long been an objective for machine learning researchers. Ideally, such a continuous learning paradigm would have the properties of knowledge retention, online learning, constant memory, task revisit capability, no task boundaries, and forward and backward transfer as briefly described in Table 1.

TABLE 1
Desired Continuous Learning Properties

| Property | Description |
|---|---|
| Knowledge | Mitigation of Catastrophic Forgetting |
| Retention | (CF) |
| On-line | Model learns from a continuous stream of |
| Learning | data in a non-episodic manner and without |
| | requiring all new class data to be available |
| | for offline i.i.d. batch generation. |
| Constant | Memory component of CL process is |
| Memory | constant regardless of the number of |
| | classes or the length of the data stream |
| Task Revisit | Model can revisit existing classes to |
| Capability | improve performance with additional |
| | data. |
| No Task | Model learns without requiring clear class |
| Boundaries | boundaries that updates only one class at a |
| | time. |
| Forward | Model learns a new task while reusing |
| Transfer | knowledge acquired from previous tasks. |
| Backward | Model achieves improved performance on |
| Transfer | previous tasks after learning a new task |
| Joint | Model jointly optimizes over multiple |
| Optimization | classes in classifier or prediction head. |

Achieving the majority of these CL objectives is non-trivial and many approaches selectively focus on just addressing a few of these desired properties. The unresolved CL issues identified in the BACKGROUND of 1) knowledge retention during incremental learning, 2) online, single-pass, non-episodic learning, and 3) joint multi-class optimization, motivate the development of new CL algorithms.

Recently, the R3CA algorithm has demonstrated a unique multi-class, classifier-focused capability of incremental learning that eliminates CF. It does this by incorporating memory of past data into its updates using a modified RLS process. This capability allows R3CA's optimization to be independent of sample arrival order and therefore be able to continuously learn from an unshuffled, multi-class data stream.

R3CA is distinct from other CL algorithms in that it does not try to update a network's underlying feature extractor incrementally but focuses instead on eliminating CF in an incrementally updated multi-class classifier. This allows R3CA to operate on the frozen feature embeddings of a pretrained feature extractor. This classification-focused approach makes R3CA well positioned to take advantage of the current trend of pretrained, self-supervised, large foundational models that are revolutionizing both computer vision and NLP with their ability to generalize well to downstream supervised tasks within a given data domain. Furthermore, it eliminates many of the challenges that other CL algorithms face that try to incrementally finetune a network's backbone on the new class data, such as 1) degrading prior class performance by changing the shared features upon which previous and frozen classifiers have been trained and 2) overfitting those features to current classes and losing those features ability to generalize well to future classes.

Thus, this classification-focused approach to CL challenges the continued utility of incrementally finetuning a network's feature extractor given the revolutionary ability of these pretrained, self-supervised foundational models to generalize to new tasks. The present embodiments focus on the potential of a new classifier-based approach to online and incremental learning and extends this examination to the field of NLP classification tasks and their foundational language models.

The present embodiments describe the Ridge Regression for Rapid Class Augmentation (R3CA) method and algorithm as applied to large language model classification tasks such as topic classification, e.g., given a text article, determining to which predetermined topic category it should be classified, and name-entity-recognition (NER), e.g., identifying new named-entities such as a word or word phrase representing a person, organization, geographical location, art-artifact, event or nationality. R3CA is a regularized version of the XRCA incremental learning algorithm that significantly improves its performance in low sample support environments.

Both XRCA and R3CA differ from many other incremental learning algorithms in that they decouple the optimization of the network's feature extraction backbone from the classifier's update on the new class data. Instead, these techniques use a frozen, pretrained feature extraction backbone and transfer these pretrained features directly to the new downstream task. This allows them to focus on sequentially optimizing a multi-class classifier and not on the additional task of incrementally updating the backbone's feature weights. This simplifies the problem since now during new class training, the optimizer is not changing the backbone weights and thereby the features upon which previous classes are classified.

The success of these pretrained self-supervised backbones increases the utility of incremental learning approaches like XRCA and R3CA that leverage self-supervision's revolutionary capabilities to produce features that transfer well to almost any class. This suggests that it may no longer be necessary for incremental learning approaches to optimize the network's feature extraction backbone individually and consecutively for each new class and deal with all the related issues.

This simplified approach enables a recursive online memory solution that allows XRCA and R3CA to optimize over all previously seen training samples and not just the ones in the current batch. This recursive memory is seen to operate equally well on mixed class batches or batches containing just the new classes. Data order becomes irrelevant, and an incrementally trained classifier is seen to obtain the same performance as a non-incrementally trained classifier.

This approach also seamlessly provides other important CL attributes such as having a constant memory, online learning, training without task boundaries and with the ability to revisit tasks to improve performance. Many of these attributes are lacking in other incremental learning approaches. In other words, XRCA's and R3CA's recursive memory eliminates the CF that plagues standard optimizers and other specialized incremental learning methods.

R3CA uses ridge-regression to regularize the XRCA. This regularization allows an R3CA classifier to be initialized using much less training data which is an important use case for incremental learning algorithms that often want to start small and progressively grow their model's capacity and accuracy as more data becomes available. Furthermore, R3CA is shown to be much more robust and computationally efficient to the sequential addition of future classes than other subset forms of regularization such as rank reduction. This makes R3CA an attractive technology for applications requiring continuous learning with streaming supervised data, in real-time, and on platforms with challenging size, weight, and power (SWaP) constraints.

The R3CA algorithm views continuous learning as an online and recursive learning process. It is based on a regularized version of the eXtending Rapid Class Augmentation (XRCA) algorithm described in commonly-owned U.S. application Ser. No. 17/083,969 which is incorporated herein by reference. The XRCA algorithm adapts the standard RLS regression task to classification by extending the regression weight vector into a classifier weight matrix where each column of the matrix estimates the likelihood of a different class. Importantly, RLS's inversed feature covariance method (IFCM) serves as the optimizer's memory and, together with its memory parameter lambda, gives it's updates a weighted memory of all previous training examples. By setting the RLS memory parameter lambda to 1, one can essentially include a stream of never-ending data into the classifier's weight estimation. This can be used to improve an existing classifier's performance with additional information gathered over long data streams.

The RLS classification task is modified for incremental learning by augmenting its existing classifier matrix with a new column for the new class weights. When this class's weight vector is matrix-multiplied by a sample's feature vector then it should produce either a +1 or −1 depending on whether that sample is associated with the class's weight vector.

A critical element of both the XRCA and R3CA algorithms is how these new class weights are initialized. Instead of initializing the new class weights randomly, these algorithms recursively compute and maintain a novel null-class weight vector that is used to initialize any new class. This new type of weight initialization is based on the key insight that any new class's column vector weights are simply weights that have not yet seen any positive class examples. Since these classification weights are updated recursively and the new classes have not been seen before, then the initial LS estimate for the new class weight vector is just the recursive solution of all the preceding negative training. In other words, by training a null-class weight vector over all the previously seen training data using a negative label we have the optimal LS initialization for any new class. After this null-class initialization, the augmented classification matrix can be recursively updated with RLS using batches containing some or none of the new class training examples.

Importantly, this type of recursive update means that the order with which the samples arrive is unimportant. The algorithm will achieve the same performance if run sequentially on a batch containing just new data or batches with class mixtures. This approach enables R3CA to operate with constant memory, in an online manner (without offline episodic training), and with no task boundaries and no limitations on revisiting old tasks.

R3CA uses ridge-regression to regularize the XRCA. This regularization allows an R3CA classifier to be initialized using much less training data which is an important use case for incremental learning algorithms that often want to start small and progressively grow their model's capacity and accuracy as more data becomes available.

Ridge regression adds a cost penalty λ to the loss function that is proportional to the norm of its solution's weights. The new cost function is shown in Eq. (1):

$${Cost}^{Ridge} = {( {T}_{k} - {X}_{k} {w}_{k} )}^{T} ( {T}_{k} - {X}_{k} {w}_{k} ) + λ {w}_{k}^{T} {w}_{k} \qquad ( 1 )$$

Here wₖ represents the classifier's weight matrix, Xₖ∈ [symbol] ^{N×F} is the data matrix consisting of a vertically stacked data matrix of N training examples in each batch, each of feature dimension F, and the label matrix Tₖ∈ [symbol] ^{N×C} contains the signed, one-hot class labels of size N×C where C is the number of classes.

This ridge regression penalty manifests itself as a weighted diagonal loading term in the computation of XRCA's IFCM. Eq. (2) shows R3CA's base model components with the new regularization parameter “λ” that determines how much to penalize a solution's use of large weight coefficients.

$${M}_{0} = {( {X}_{0}^{T} {X}_{0} + λ I )}^{- 1} \qquad ( 2 )$$

$${w}_{0} = {M}_{0} {X}_{0}^{T} {T}_{0}$$

$$Δ {w}_{0} = {M}_{0} {X}_{0}^{T} {T}_{Neg}$$

These three regularized elements: M₀∈ [symbol] ^{F×F}, w₀∈ [symbol] ^{F×C}, Δwₖ∈ [symbol] ^{F×l} make up the components of an R3CA base model and will be recursively updated as the additional data is presented. The T_{Neg} term appearing in the null class's Δwₖ equation consists of a vector of −1's of dimension N×1, representing negative labels for all base model examples.

For each new batch of additional training data, the R3CA algorithm first looks to see if any samples in the batch contain new class labels. If a batch contains only existing class data (i.e., all class labels are less than the number of columns in the current classifier), the R3CA algorithm computes the RLS updates and the new update for the null-class initialization vector Δwₖ, as seen below in Eq. (3)

$${M}_{k + 1} = {M}_{k} - {M}_{k} {{x}_{k + 1}^{T} ( 1 + {x}_{k + 1} {M}_{k} {x}_{k + 1}^{T} )}^{- 1} {x}_{k + 1}^{T} {M}_{k} \qquad ( 3 )$$

$${w}_{k + 1} = {w}_{k} + {M}_{k + 1} {x}_{k + 1}^{T} ( {T}_{k + 1} - {x}_{k + 1}^{T} {w}_{k} )$$

$$Δ {w}_{k + 1} = Δ {w}_{k} + {M}_{k + 1} {x}_{k + 1}^{T} ( {T}_{Neg} - {x}_{k + 1}^{T} {w}_{k} )$$

If a batch contains a new class label (i.e., the label is greater than the number of columns in the current classifier), the R3CA algorithm first augments the existing classification matrix w_{k,} with a null-class vector Δwₖ as shown in Eq. (4).

$${w}_{k} = [ {w}_{k ,} Δ {w}_{k} ] \qquad ( 4 )$$

The experiments described herein illustrate the R3CA algorithm's superior incremental learning capabilities for the NLP tasks of topic classification and NER. These experiments were run on NVIDIA Tesla T4 GPU with 16 GB of GPU memory. One skilled in the art will appreciate alternative and/or additional hardware which may be used and/or added as needed.

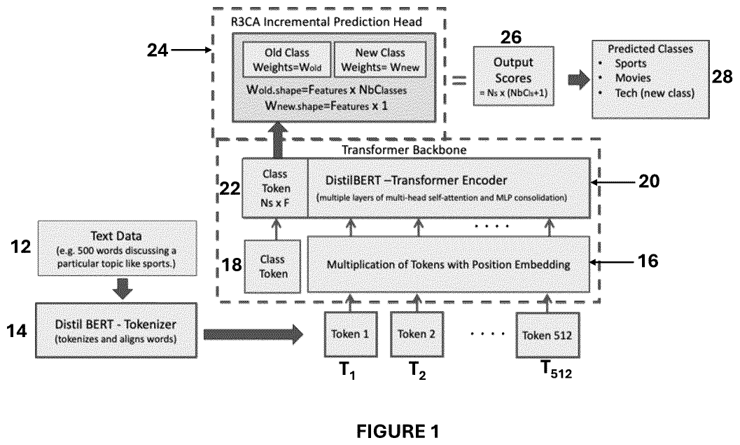

FIG. 1 provides a block diagram of our approach for topic classification using a R3CA incremental classifier in accordance with an embodiment herein. At a high level, the process consists of a R3CA incremental classifier operating on the features produced by a pretrained, self-supervised, DistilBERT language model as described in Sanh et al., DistilBERT, a distilled version of BERT: smaller, faster, cheaper and lighter, arXiv:1910.01108v4 (2020). The DistilBERT transformer architecture includes a stack of 6 hidden layers made up of transformer encoders each having a feed-forward neural network and a multi-head, 12 heads, self-attention mechanism in each layer. The model can recognize contextual associations between words in the input sequence thanks to the self-attention mechanism. DistilBERT incorporates knowledge distillation during its training process; learning from a larger, more complex model (e.g., BERT) by mimicking its behavior. This distillation process helps transfer the knowledge learned by the larger model to the DistilBERT model. DistilBERT uses a distilled version of the attention mechanism found in BERT.

More specifically, the inputs to the process are text articles (data) 12 of around 500 words in length that cover a range of topics like business, sports, and entertainment. These text articles 12 are run first through a tokenizer 14 to translate the article's words into token vector embeddings, tokens, T₁, T₂ . . . T₅₁₂. These text token embeddings T₁, T₂ . . . T₅₁₂ are then multiplied with some positional coding 16, and appended with a class token 18, which is then fed into the DistilBERT transformer encoder 20. The transformer uses multiple layers of multi-head-attention to uncover the relative context between the different word embeddings. The class token from the last layer is used to summarize the entire article's sequence of token embeddings into a single vector embedding 22. This class-token embedding 22 is the feature vector upon which the R3CA classifier 24 operates to generate output scores 26 and assign a topic class prediction 28. During incremental training, when a new topic class becomes available, the R3CA classification matrix is augmented with a new null-class vector and then trained on feature samples corresponding to the new topic article and label. During inference, the R3CA classifier operates on a topic article's feature embedding and outputs a classification score 26 that is jointly optimized over all classes in the training set.

A first experiment for topic classification used the BBC—new corpus data that contains articles categorized into five different topics of business, entertainment, politics, sport, and technology. This data set is well balanced with each training class having roughly 400 training samples and 33 test samples. We initialized an R3CA classifier on the first two classes (business and entertainment) using the output features of the pretrained Distill-BERT model. We then incrementally augmented and trained the R3CA classifier over each of the remaining classes and observed the classifier's different all-class and trained-class performance metrics.

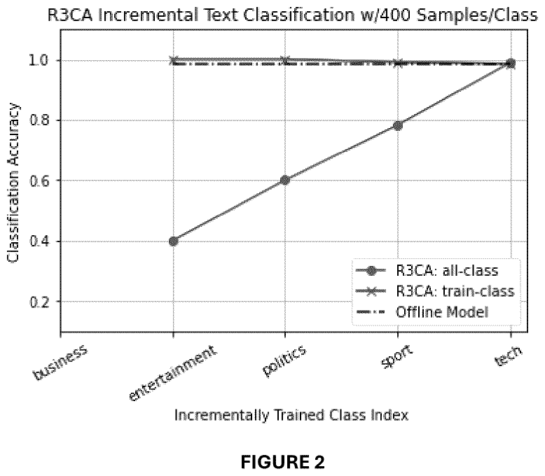

FIG. 2 shows the results for the first experiment. The all-class performance metric (red) measures the classifier's performance accuracy over a test set that includes all 5 classes regardless of whether the classifier has been trained on that class yet. The all-class metric is used to illustrate the growing capacity of a classifier as it incrementally learns new classes.

Also note that after the R3CA classifier has been trained over all 5 classes, it's all class accuracy has obtained the classification level of a classifier trained in an off-line manner (dashed line) that has access to all training classes. This result highlights R3CA's ability to operate independent of class training sample order which is a desirable characteristic for learning from a non-curated data stream.

FIG. 2 also shows the train-class performance metric, which measures the classifier's performance accuracy over a test set that includes only the classes upon which the classifier has already been trained. We see it starts off with a slightly higher classification than the offline model's 5 class accuracy, since two classes are easier to classify correctly than five.

Thus, both metrics indicate that the R3CA classifier can learn the new classes incrementally in a manner that matches the performance of a classifier trained with upfront access to all data. None of the other well-known and surveyed incremental learning algorithms were able to consistently demonstrate the elimination of CF when trained incrementally on new classes.

A second experiment also explores the topic classification task but now with fewer training samples. This second experiment highlights that the new R3CA continuous learning algorithm can exceed the performance of standard, non-regularized optimizers in low sample support scenarios.

In this experiment we reduced the training examples per class from 400 to 180. The total number of training examples for all 5 classes is only 900 which barely exceeds the feature space dimensionality of 768 that the weight parameters span.

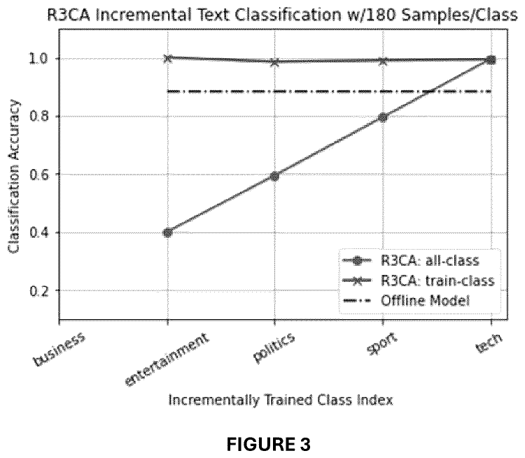

This low sample support causes the weight solutions to overfit and makes the weights less able to generalize well to test class examples. FIG. 3 shows that the result is a reduction in the offline classifier's performance from 99% to 88% accuracy.

R3CA's classifier, with its regularized least squares solution, is however still able to generalize well to the test data and its all-class and trained class metrics are largely unaffected and still able to obtain close to 100% accuracy on the test data after it has trained incrementally over the last 3 classes.

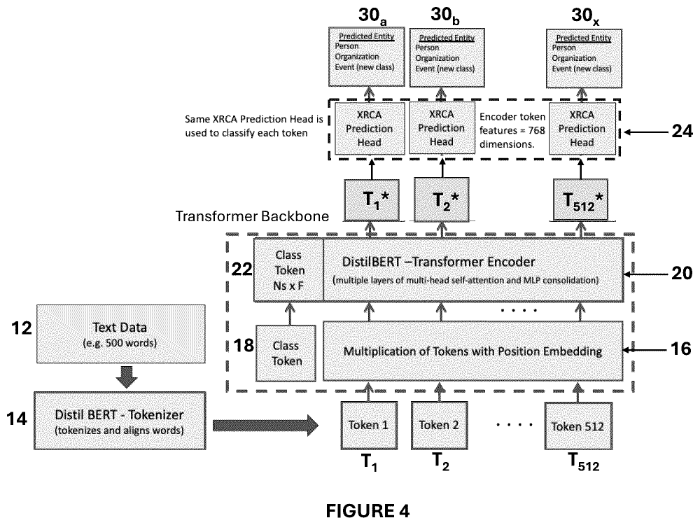

FIG. 4 shows our approach for incremental learning when applying R3CA to Named-Entity-Recognition (NER). This incremental learning task identifies new named-entities such as a word or word phrase representing a person, organization, geographical location, art-artifact, event or nationality.

Note for this task we do not want to summarize and classify an entire text article but rather separately classify each word as belonging or not to a particular word category or named entity. If the word does not belong to any named entity category it is still given a classification label of non-entity. Thus, one article of text can contain many entity labels as well as an almost overwhelming number of non-entity examples.

FIG. 4 shows the slightly modified processing flow for the NER task. At a high-level, the processing task still consists of an R3CA classifier operating on top of the features produced by a pretrained, self-supervised, foundational language model (i.e. DistilBERT). However, instead of using the transformer's class-tokens to summarize a sequence of words, R3CA operates directly on the last layer's transformed token embeddings, e.g., T₁*, T₂* . . . T₅₁₂*. Since a single entity can consist of multiple words or tokens (e.g. first name, last name) each entity will have a label referring to the beginning of the word entity or one of its following intermediary labels, e.g., predicted entity 30ₐ, 30_{b} . . . 30ₓ.

The implementing experiments described below were run on the CoNLL NER dataset that consisted of 17 labels comprising the non-entity and 8 entity classes, where each entity each with a separate beginning and intermediary tag.

In a first NER experiment (with high sample support), to separate the incremental learning performance from other performance factors caused by data skew, our first NER experiment was run over the first 9 classes. In this experiment, the R3CA classifier is initialized on the first two classes and then incrementally trained on the remaining 7 classes using a total of 2000 training examples and 100 test examples.

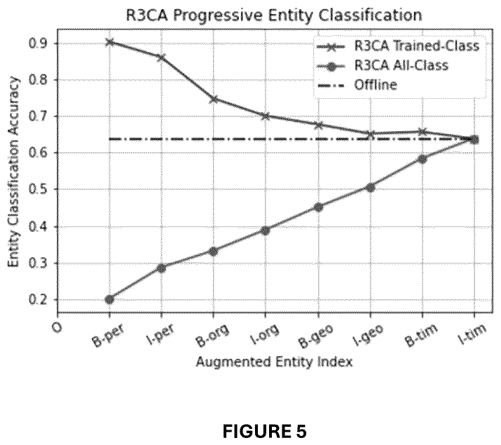

The results for this first NER experiment are plotted in FIG. 5. The first result to stand out is that this NER task appears much more difficult than the earlier topic classification model. For example, in this experiment the offline model trained non-incrementally over all 8 classes only achieves a classification accuracy of approximately 65%.

The difficulty of this NER task is further seen in the manner that R3CA's trained class accuracy decreases substantially as the model incorporates additional classes. This suggests that different entity features are similar and overlapping which causes the classifier to readjust to all its class weights as additional entities are added to jointly optimize across all the classes. The similarity of many of these tokens embedding could be expected given the correlation between an entity's beginning and intermediate tokens.

The second important result to note is that both the train-class and all-class performance metrics converge again to the full class accuracy in this high sample support scenario (2000 examples/class). These results indicate that R3CA has eliminated the CF associated with learning incrementally over multiple classes.

The second NER experiment analyzes more deeply into what is happening in each incremental class update by examining a classifier's performance as the new class is trained and the old classes reevaluated after each batch iteration. The experiment highlights how R3CA is able to remember its old classes even as it trains on just the new class data. Here we initialize a two-class classifier on the non-entity and B-person tags and added the new I-person label. We then train over just the new tag label using both a standard SGD optimizer and the new R3CA optimizer.

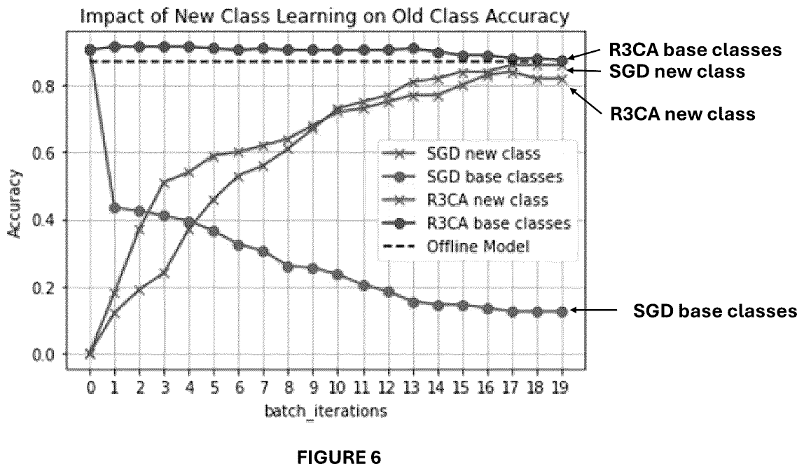

FIG. 6 shows the performance accuracy on the first two classes (old) and the new class after each training iteration for both optimizers. We see how the SGD-based classifier loses classification accuracy on its old (base) classes even as it learns the new class. In contrast, R3CA jointly optimizes its old (base) class weights while it learns its new class. These metrics show how R3CA jointly optimizes across old and new classes and avoids CF.

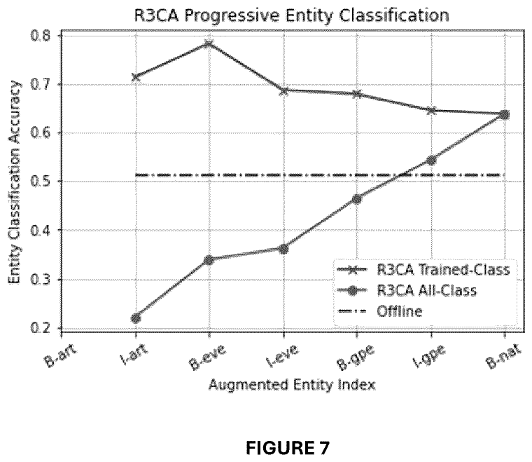

The final experiment runs R3CA over the last 7 CoNLL NER entity classes to highlight a limited sample support scenario for the NER application. In this experiment we used 150 training examples per class and ˜20 test examples. As shown in FIG. 7, the classification accuracy of the off-line model trained over all 7 classes barely achieved more than 50% and serves as a performance target. The R3CA classifier was initialized on the two classes (B-art, I-art) and incrementally added the remaining 5 classes. We see that R3CA was able to incrementally learn new classes better than a non-regularized, non-sequentially trained classifier operating over all 7 classes.

The ability to train models using continuous data streams is an important but difficult technical goal given conventional optimizers inability to retain knowledge of prior training data. When incrementally training on just the new class data, this inability to remember prior data results in CF of previously learned classes. For online, multi-class learning applications, this lack of optimizer memory results in the training algorithm being dependent on the class order of incoming data stream which is impractical in most real-world applications.

The embodiments herein demonstrate the R3CA CL algorithm for the first time in the NLP domain for the tasks of topic classification and NER. Experiments showed that R3CA recursive approach to memory makes it independent of incoming class order and therefore immune to CF. This ability is exceptional among current incremental learning algorithms.

Furthermore, within the context of a classifier approach, R3CA addresses many of the other desired objectives for CL that are typically ignored in incremental learnings almost singular focus on mitigating CF. These include R3CA's online, non-episodic learning capability, R3CA's constant memory component with its IFCM and null class vector whose size does not change based on the length of the data stream, R3CA's ability to easily revisit tasks with additional training data, and its ability to handle mixed class batches without depending on designated task boundaries. In addition, R3CA is alone in providing a joint multi-class classifier approach to incremental learning.

Finally, R3CA's classifier focused approach to CL pairs well with the growing utility of large, pretrained, self-supervised models. We hope this new approach offers rapid training options to improve CL on unfiltered data streams in NLP and beyond.

Exemplary hardware (also referenced herein as “chip(s)”) and hardware functions for implementing the embodiments described herein are well known and understood to those skilled in the art. Chips for use with the present embodiments include logic functionality implemented through semiconductor devices, e.g., millions or billions of transistors (MOSFET) (also called “nodes”) and electrical interconnects, for creating basic logic gates to perform basic logical operations. These basic logic gates are combined to perform complex high volume, parallel computing required for the training and inference of the DNNs of the embodiments described herein. Chips may also include memory capabilities for storing the data on which the logic functionality is implemented. Exemplary memory capabilities include dynamic random-access memory (DRAM), NAND flash memory and solid-state hard drives.

As referenced above, the training and inference examples described herein were run on an NVIDIA Tesla T4 GPU with 16 GB of GPU memory. Specifications for the NVIDIA Turing GPU architecture can be found in the “NVIDIA Turing GPU Architecture” white paper WP-09183-001_v01 (2018) available on-line which is incorporated herein by reference in its entirety.

One skilled in the art will appreciate that this is but one specific example of a chip which may implement the training and inference embodiments described herein Exemplary chip types include graphics processing units (GPUs), field programmable gate arrays (FPGAs), and application-specific integrated circuits (ASICs). FPGAs include logic blocks (i.e. modules that each contain a set of transistors) whose interconnections can be reconfigured by a programmer after fabrication to suit specific algorithms, while ASICs include hardwired circuitry customized to specific algorithms. The selection of particular hardware includes factors such as computational power, energy efficiency, cost, compatibility with existing hardware and software, scalability, and task (e.g. optimized for training or inference). For a detailed description of AI chip technology, see Khan et al., “AI Chips: What They Are and Why They Matter And AI Chips Reference”, CSET center for Security and Emerging Technology (April 2020) which is incorporated herein by reference in its entirety.

Certain embodiments are directed to a computer program product (e.g., nonvolatile memory device), which includes a machine or computer-readable medium having stored thereon instructions which may be executed by a computer (or other electronic device) to perform these operations/activities.

Although several embodiments have been described above with a certain degree of particularity, those skilled in the art could make numerous alterations to the disclosed embodiments without departing from the spirit of the present disclosure. It is intended that all matter contained in the above description or shown in the accompanying drawings shall be interpreted as illustrative only and not limiting. Changes in detail or structure may be made without departing from the present teachings. The foregoing description and following claims are intended to cover all such modifications and variations.

Various embodiments are described herein of various apparatuses, systems, and methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” “an embodiment,” or the like, means that a particular feature, structure, or characteristic described in connection with the embodiment is included in at least one embodiment. Thus, appearances of the phrases “in various embodiments,” “in some embodiments,” “in one embodiment,” “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation.

Any patent, publication, or other disclosure material, in whole or in part, which is said to be incorporated by reference herein is incorporated herein only to the extent that the incorporated materials do not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

I claim:

1. A system for incrementally training a classifier for predicting an article's topic class, the system comprising:
a tokenizer for translating words of each input text article into token vector word embeddings;
a transformer backbone for
(i) multiplying the token vector embeddings with a positional coding and appending a class token thereto;
(ii) transforming, by an encoder, the token vector embeddings with positional coding to determine a relative context between the different token vector word embeddings for the text article;
(iii) summarizing the text article's sequence of transformed token vector embeddings with positional coding in a single vector class-token embedding; and
an incremental classifier trained on known topic classes for
(iv) receiving the single vector class-token embedding and determining that the text article is directed to a new topic class;
(v) augmenting a classification matrix with a new null-class weight vector; and
(vi) training the incremental classifier on feature samples corresponding to the text article directed to the new topic class.

2. The system of claim 1, wherein the encoder applies multiple layers of multi-head-attention to determine the relative context between the different token vector word embeddings.

3. The system of claim 2, wherein the encoder includes six layers each including twelve heads.

4. The system of claim 1, wherein the transformer backbone is a pretrained, self-supervised, model.

5. A system for incrementally training a classifier for predicting classification of one or more entities in a text article, the system comprising:
a tokenizer for translating words of each input text article into token vector word embeddings;
a transformer backbone for
(i) multiplying the token vector embeddings with a positional coding and appending a class token thereto;
(ii) transforming, by an encoder, the token vector embeddings with positional coding to determine a relative context between the different token vector word embeddings for the text article;
(iii) summarizing the text article's sequence of transformed token vector embeddings with positional coding in a single vector class-token embedding; and
an incremental classifier trained on known entity classes for
(iv) receiving each transformed token vector embedding with positional coding and determining that the text article includes a new entity class;
(v) augmenting a classification matrix with a new null-class weight vector; and
(vi) training the incremental classifier on feature samples corresponding to the text article directed to the new entity class.

6. The system of claim 1, wherein the transformer applies multiple layers of multi-head-attention to determine the relative context between the different token vector word embeddings.

7. The system of claim 6, wherein the encoder includes six layers each including twelve heads.

8. The system of claim 1, wherein the transformer backbone is a pretrained, self-supervised, model.

9. The system of claim 1, wherein augmenting the classification matrix with a new null- class weight vector includes adding a new column for new class weights for the new topic class.

10. The system of claim 9, further comprising:
initializing the new class weights wherein a new class's column vector weights are weights that have not yet seen any positive class samples and an initial least-squares estimate for the new class weight vector is the recursive solution of all the preceding negative training.

11. A non-transitory computer-readable storage medium having computer-executable instructions stored thereon for predicting an article's topic class, which when executed by one or more processors, cause the one or more processors to perform operations comprising:
tokenizing words of an input text article into token vector word embeddings;
multiplying the token vector embeddings with a positional coding and appending a class token thereto;
transforming the token vector embeddings with positional coding to determine a relative context between the different token vector word embeddings for the input text article;
summarizing the input text article's sequence of transformed token vector embeddings with positional coding in a single vector class-token embedding;
receiving the single vector class-token embedding at a classifier trained on known topic classes and determining that the input text article is directed to a new topic class;
augmenting a classification matrix with a new null-class weight vector; and
training the incremental classifier on feature samples corresponding to the input text article directed to the new topic class.

12. The non-transitory computer-readable storage medium of claim 11, wherein augmenting the classification matrix with a new null-class weight vector includes adding a new column for new class weights for the new topic class.

13. The non-transitory computer-readable storage medium of claim 12, further comprising:
initializing the new class weights wherein a new class's column vector weights are weights that have not yet seen any positive class samples and an initial least-squares estimate for the new class weight vector is the recursive solution of all the preceding negative training.

14. A non-transitory computer-readable storage medium having computer-executable instructions stored thereon for incrementally training a classifier for predicting classification of one or more entities in a text article, which when executed by one or more processors, cause the one or more processors to perform operations comprising:
multiplying the token vector embeddings with a positional coding and appending a class token thereto;
transforming, by an encoder, the token vector embeddings with positional coding to determine a relative context between the different token vector word embeddings for the text article;
summarizing the text article's sequence of transformed token vector embeddings with positional coding in a single vector class-token embedding;
receiving each transformed token vector embedding with positional coding and determining that the text article includes a new entity class;
augmenting a classification matrix with a new null-class weight vector; and
training the incremental classifier on feature samples corresponding to the text article directed to the new entity class.

15. The non-transitory computer-readable storage medium of claim 14, wherein augmenting the classification matrix with a new null-class weight vector includes adding a new column for new class weights for the new topic class.

16. The non-transitory computer-readable storage medium of claim 15, further comprising:
initializing the new class weights wherein a new class's column vector weights are weights that have not yet seen any positive class samples and an initial least-squares estimate for the new class weight vector is the recursive solution of all the preceding negative training.
